(19) United States
(12) Patent Application Publication
(10) Pub. No.: US 2007/0088744 A1
(43) Pub. Date: Apr. 19, 2007

(54) System and method for automatic directory management in server environments

(76) Inventors: Joseph Webber, Houston, TX (US); Thomas Price, Houston, TX (US); Cheng Lim Tan, Missouri City, TX (US); Ed Schlichtenmyer, Crosby, TX (US); Ziauddin A. Chowdhury, Cypress, TX (US); Earl Eugene Callens III, Deer Park, TX (US)

Correspondence Address: CHAD A. GUICE, ESQ., 5375 Appledore Lane, Tallahassee, FL, 32309, US

(21) Appl. No.: 11/249,803

(22) Filed: Oct. 13, 2005

(51) Int. Cl. G06F 17/00

(52) U.S. Cl. 707/104.1

(57) ABSTRACT

A new method and directory management system for creating and maintaining directories, linking accounts, and assigning appropriate access rights when triggering events occur as prescribed by the business rules of the organization. To accomplish this, the directory management system acts as a bridge between the organizations commonly used transaction systems and the file system directory used by the organization. The directory management system generally operates by defining triggering events which are represented by defined observable changes in the commonly used transaction systems of the organization, incorporating the organizations business rules to prescribe account and directory actions that should be taken when the triggering events occur, and providing a system to monitor for the occurrence of the triggering events and execute the account and directory actions in response to the triggering events.

### BACKGROUND OF THE INVENTION

1. Field of the Invention.

This invention relates to the field of directory creation and maintenance in server environments. More specifically, the invention comprises a method and system for automatically creating users, groups and server file system directories, linking accounts, and providing appropriate access rights based on changes in other transaction systems and other defined inputs.

2. Description of the Related Art.

Businesses of all sizes routinely utilize computer networks in order to share resources such as applications, data and storage. In doing so, computer networks offer businesses many potential benefits including enhanced productivity, efficiency, and security for sensitive or valuable information. Although computer networks come in many varieties, they generally share several common features. For example, most networks include two main classes of access privileges—administrator and user. A network administrator generally has the ability to configure and manipulate the system settings, user settings, and application settings. Users generally utilize system resources for various purposes. Accordingly, a user's access rights are more limited than the network administrator.

Another common feature of computer networks is the distributed nature of the systems. The term “distributed” is used because processing and storage responsibilities are shared by various components of the system including end-user computer terminals and central servers that could be located in different physical locations. To accomplish these tasks, networked computers and other devices communicate remotely using various connection means.

Directory services typically run on a directory server computer and are commonly used to provide a centralized location for storing information about networked devices and users. Directory services provide both a database storage system for storing this information and a service for adding, deleting, and modifying data stored in the directory. A directory service acts as the interface to the directory and provides access via access rights to data contained in the directories. In this regard, the directory service acts as a central authority that authenticates resources and manages identities.

Directory services should not be confused with file system directories or directories. Directories generally hold the information about objects that are managed by a directory service. Directories generally fall within at least one of three categories—internal, external, or application specific. Internal directories are used within a businesses network for publishing information about users and resources of the business network. Generally, internal directories are not accessible to business outsiders. External directories are typically maintained in a perimeter network between the business network and the public Internet. External directories typically contain customer, partner, or client information for users who access external software applications and services. Application directories contain information relevant to specific applications. This information is typically only significant to the application itself and is therefore maintained in the directory associated with the application.

Recent efforts have focused on streamlining the administration of networks and their directories. For example, older network systems employed separate directory services for operating the domain, providing email services, utilizing databases, and accessing applications remotely. In addition, updating a network often required an administrator to enter a change on the business server and then manually “upload” the change onto each of the servers in the business network. Newer networks may employ a central directory or information hub which regulates network devices, user accounts, servers, applications, and other directories that are within the business network. For example, through a single entry into the central directory, the administrator can enable a user to access the network, access an account for messaging, and have specific other access privileges for other applications.

Despite these developments, administration of networks and directories can be a very time consuming and costly process for many businesses. For many businesses, administrators are still required to create and manage thousands of network, file systems, and email accounts within their business. Accordingly, it would be desirable to have a system that would automatically create directories, link accounts, and provide appropriate access rights based on changes in other transaction systems and other defined inputs

### BRIEF SUMMARY OF THE PRESENT INVENTION

The present invention comprises a new method and directory management system for creating and updating directories, linking accounts, and assigning appropriate access rights when triggering events occur as prescribed by the defined business rules of the organization employing the management system. To accomplish this, the directory management system acts as a bridge between the organizations commonly used transaction systems and the file system directory used by the organization. The directory management system generally operates by specific triggering events which are represented by defined observable changes in the commonly used transaction systems of the organization, incorporating the organizations business rules to prescribe account and directory actions that should be taken when the triggering events occur, providing a system to monitor for the occurrence of the triggering events, and then executing the account and directory actions in response to the triggering events.

### BRIEF DESCRIPTION OF THE SEVERAL VIEWS OF THE DRAWINGS

FIG. 1 is a block diagram illustrating a configuration of a system for automatically managing a directory service.

FIG. 2 is a block diagram illustrating an example of the implementation of the present invention for a school system.

FIG. 3 is a block diagram showing a preferred embodiment of the present invention.

FIG. 4 is an illustration of a customization tool graphical user interface.

### REFERENCE NUMERALS IN THE DRAWINGS

| | | | |
|---|---|---|---|
| 10 | directory management system | 12 | data source |
| 14 | rollup connector | 16 | insert/update sorter |
| 18 | initial insert query | 20 | initial update query |
| 22 | create account function | 24 | directory actions |
| 26 | update limited fields function | 28 | directory actions |
| 30 | validation query | 32 | log error function |
| 34 | stop | 36 | student information system |
| 38 | human resource system | 40 | directory service |
| 42 | input device | 44 | memory |
| 46 | monitoring device | 48 | software |
| 50 | file system directory | 52 | customization tool |
| 54 | location list box | 56 | change type list box |
| 58 | field limiter list box | 60 | location list box |
| 62 | action list box | 64 | type limiter list box |
| 66 | command button | 68 | command button |

### DETAILED DESCRIPTION OF THE INVENTION

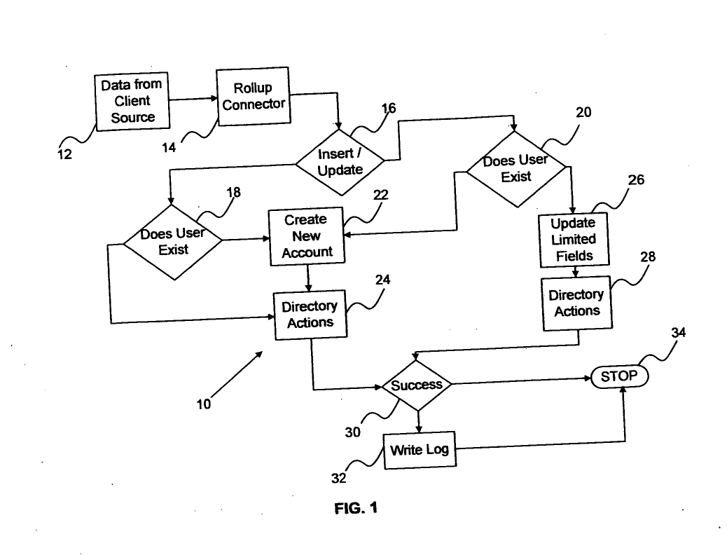

A configuration for a directory management system is provided in FIG. 1. Directory management system 10 creates directories, links accounts, and assigns appropriate access rights when triggering events occur as prescribed by the business rules of the organization employing the management system. To accomplish this, directory management system 10 acts as a bridge between the organization's commonly used transaction systems, the directory service, and the file system directory used by the organization. Directory management system 10 generally operates by defining triggering events which are represented by defined observable changes in the commonly used transaction systems of the organization, incorporating the organizations business rules to prescribe account and directory actions that should be taken when the triggering events occur, providing a system to monitor for the occurrence of the triggering events, and then executing the account and directory actions in response to the triggering events.

As illustrated in FIG. 1, rollup connector 14 is provided to aggregate data from data source 12. Data source 12 can include data provided from various sources. Generally, data source 12 will include common transaction systems used by the organization such as databases and spreadsheets. One example of a data source is the human resources database system which is used to log employment and other relevant information regarding employees of the organization. This database system generally includes an employee's first and last name, contact information, and group and subgroup affiliations within the organization. Data source 12 can also be a direct manual input into directory management system 10. For example, a specialized graphical user interface can be provided with directory management system 10 to allow the user to enter changes directly into the directory management system.

In the preferred embodiment, rollup connector 14 aggregates data in a relational method. For example, each data point that is aggregated includes characteristic information about that data. Data can also be aggregated by rollup connector 14 in a nonrelational manner, however. Rollup connector 14 can be configured to operate continuously so that it is always collecting data from data source 12 or it can be configured so that it only operates when there is a change made in data source 12. Similarly, it can be configured to operate periodically. For example, it can be configured to aggregate data every three hours. To minimize the memory and processing requirements of rollup connector 14, it can be further configured to only aggregate the changes to data source 12, or the deltas, omitting unchanged data from the aggregation process.

The data aggregated by rollup connector 14 is then filtered by insert/update sorter 16. Insert/update sorter 16 makes an initial determination whether the data represent changes to existing data or data that is altogether new. If the nonpreferred configuration of rollup connector 14 is used, data that is neither changed nor new can be filtered out at this point. If the data represents a new entry as determined by insert/update sorter 16 it is characterized as an “insert” and is further processed by initial insert query 18. If the data represents a change to an existing entry, the data is characterized as an “update” and is further processed by initial update query 20.

Both “inserts” and “updates” can be defined as triggering events for carrying out prescribed changes to the directory service of the organization. In the aforementioned example regarding the human resources department, the entry of a new name in a database, where the name is identified as being a member of the human resources department can be a triggering event. This triggering event causes directory management system 10 to create a new account, and provide the account linkages and access rights that are appropriate for a member of the human resources department.

Initial insert query 18 determines whether the “insert” is associated with an existing user or is associated with a new user. Initial insert query 18 can make this determination by comparing the insert with an archived copy of data source 12. In this example, the archived copy of data source 12 can be created and utilized as a data store. Alternatively, if the preferred configuration of rollup connector 14 is used, the determination can be made based purely on the characteristics of the relational data. For example, the characteristic information included with a relational data point can include a timestamp for when the user's account associated with the data point was created, if at all. If initial insert query 18 determines that the “insert” is associated with an existing user (i.e., a user account already exists for the “insert”), initial insert query 18 directs the “insert” to directory actions 24. In this capacity, directory actions 24 act as a function for automatically executing the prescribed change in the directory service and file system directory for the organization. The prescribed change, as mentioned previously, is associated with organization's business rules. If the “insert” is not associated with an existing user, create account function 22 creates a new account in the directory for the user. The “insert” is then directed to directory actions 24 where other changes are made to the file system directory and directory service in accordance with the business rules of the organization.

Directory actions 24 include many different types of changes to the directory service including assigning access rights, creating email accounts, and linking accounts. As mentioned previously, directory actions 24 are functions that automatically implement prescribed changes to the directory service as provided by the organizations business rules. Accordingly, directory management system 10 can be customized for an organization. This customization requires defining the organization's business rules, usually by the administrator of the network. Defining a business rule is generally a process of determining and identifying the type of access rights and accounts that should be created for a user of the system based on the classifications of the user or the identity of the user. For example, an administrator may give users who are a member of an organization's human resource department access privileges to certain functions on the server. The organization may also provide that certain types of users do not have access to the public Internet from the organization's network. These business rules can be translated into specifically prescribed changes in the directory service for the organization. The changes to data source 12, both inserts and updates can be defined as triggering events for invoking the prescribed changes as described subsequently.

As mentioned previously, entries classified as “updates” are directed to initial update query 20. Like initial insert query 18, initial update query 20 determines whether the “update” is associated with an existing user or is associated with a new user. If it is determined that the user does not exist, create account function 22 creates a new account in the directory for the user. The “update” is then directed to directory actions 24 where other changes are made to the directory system in accordance with the business rules of the organization. If it is determined that the “update” relates to an existing user, the “update” is directed to the update limited fields function 26. Update limited fields function 26 then directs the update to directory actions 28 where the changes are made in data source 12, including creating a new archived copy of data source 12 for determining future changes. Directory actions 28 operates similar to directory actions 24 and executes the appropriate changes to the directory system.

After directory action 24 or directory action 28 occur, validation query 30 verifies that the prescribed changes have in fact taken place. If there was an error in executing the prescribed changes, log error function 32 reports that an error has occurred. The administrator can manually enter the appropriate changes to the directory if the prescribed changes do not occur automatically. If validation query 30 does verify that the prescribed changes have been made to the directory service, directory management system 10 terminates the process at stop 34.

### EXAMPLE

Directory management system 10 may be better understood by the following example. In the following example, directory management system 10 is employed in a school district's system to create and maintain network accounts and email accounts.

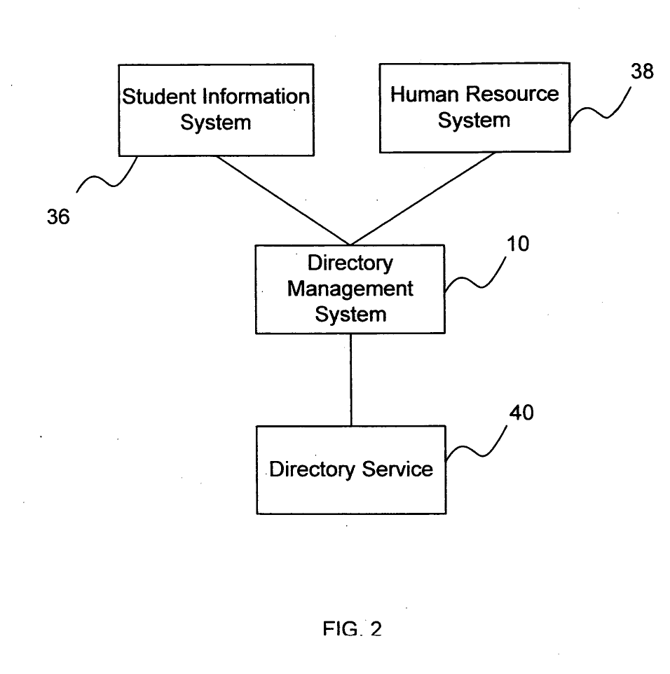

As illustrated in FIG. 2, the example school district has student information system 36 and human resource system 38. Although student information system 36 and human resource system 38 are illustrated sharing directory service 40, student information system 36 and human resource system 38 can also have their own directory service. Directory management system 10 provides a bridge between student information system 36, human resource system 38 and directory service 40.

Student information system 36 and human resource system 38 are both examples of data sources. As an example of student information system 36, the example school district may use a database to maintain a list of enrolled students in each of the schools. As students are registered in the school district, directory management system 10 immediately and automatically creates a network account, network ID, network password, and home directory for each of the students. Additionally, the school district can create student email accounts, if desired. All rights to files, directories, and applications are assigned automatically based on the information contained in the student information system. The reader will appreciate that this action can be done to incorporate other systems used by the organization in addition to student information system 36 and human resource system 38 to automatically create accounts and assign access rights as appropriate for the organization.

The registration of a student, in the above example, is a triggering event. When directory management system 10 observes the triggering event, it automatically executes the prescribed changes in accordance with the school district's business rules. In this case, the school district has elected to provide a network account and home directory for each of the students. If the school district elected to create student email accounts for enrolled student, this prescribed change to the directory service could also be executed.

Returning to the example, the school district may desire to have each of the student accounts automatically maintained over the life of the student's academic career. As a student moves to another campus or building, graduates, or leaves the district their account can be automatically moved to the new campus, disabled, or moved to an inactive container. These actions can be further refined based on the school district's business rules. This allows the user to easily create and maintain a unique identity for each and every child in the school district.

Furthermore, as a teacher is hired into the school district, directory management system 10 can immediately and automatically creates a network account, network ID, network password, and home directory for the teacher. Additionally, teacher's email accounts can also be automatically created when their network account is established. All rights to files, directories and applications are assigned automatically based on the information contained in human resource system 38.

As with student accounts, teacher accounts can be automatically maintained over the life of the teacher's career within the district. If a teacher moves to another campus, building, or classroom their account is automatically modified to reflect the desired changes and access rights. Accounts for teachers leaving the school district can be moved to an inactive status, deleted, deactivated, or altered in accordance with the school district's business rules.

In most school systems, district staff members have needs that differ from that of teachers. Access rights ranging from a district wide for all information to that of a particular campus may vary depending on the requirements of their job. Directory management system 10 can be configured to automatically assign the proper level of authority to the district staff based on the desired security model for the district.

Once directory management system 10 is configured to the specific business rules of the organization, network administrators no longer have to manually create and manage the thousands of network, file system, and email accounts within the district. When a change is made to student information system 36, human resource system 38, or any other application providing data to directory management system 10, action will be taken based on the districts business rules to alter accounts, modify access, change passwords, and update restrictions as appropriate. Those who are familiar with prior manually updated directory services will appreciate that that this will reduce the amount of time and work required to update the directory service and file system directory for the organization and will also ensure better accuracy of the resulting entries by reducing human intervention.

Directory management system 10 can be implemented as an application which is installed on a directory server computer. Directory management system 10 acts as a bridge between and communicates with the directory service and the file system directory for the network. In the aforementioned school district example, directory management system detects a new teacher or student entering the school system with its “listener” (the management system's process of detecting the defined observable changes for the network system) and acts in accordance with the defined business rules. Directory management system 10 can write directly to the network's directory service to create a network account for the new student or teacher. The application may then assign the appropriate access rights directly in the directory service as defined by district's business rules. The application may then write directly to the file system directory to create a “home” directory, a file system entry, and assigns the appropriate access rights to the teacher or student by writing directly to the directory service. Also, additional demographic data, group assignments, passwords and access rights may also be automatically assigned according to the business rules.

The application may be configured to create email accounts. For example, if the school requires a teacher to receive an email account, the application can write directly to the directory service and insert the required information for the email account. The password and access rights are automatically assigned at this time also. If the “listener” detects that a teacher has been fired and the district's business rules requires that the teacher no longer have a district email account, the application can automatically disable or delete the email account by writing to the directory service.

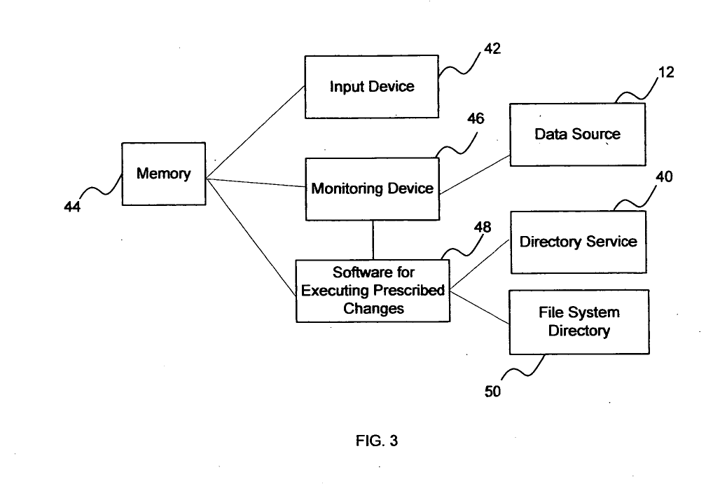

Although directory management system 10 may be implemented in many forms, a preferred configuration for a system of networked computers employing directory management system 10 is illustrated in FIG. 3. Input device 42 is provided for allowing the user to customize directory management system 10 to the needs of the user's organization. Using input device 42, the user may describe a triggering event, corresponding to an observable change in data source 12 for which the user wishes to evoke a change in directory service 40 and file system directory 50. The user may describe the triggering event in computer readable code directly or input device 42 may be configured to create the description in computer readable code for the user. The user may also input the desired changes to be made to directory service 40 and file system directory 50 via input device 42. Input device 42 may be a software tool which is made accessed by a network administrator or it may take some other form. In the preferred embodiment, input device 42 is a software tool having a graphical user interface whereby an administrator or user may select definable characteristics of the triggering event thereby creating an “event description.” The same software tool may also be used to enter or select a “change description” of the prescribed changes to be made to directory service 40 and file system directory 50 when the triggering event is observed. The “event description” and corresponding “change description” are then stored in memory 44. Multiple triggering events and corresponding prescribed changes may be entered and stored this way.

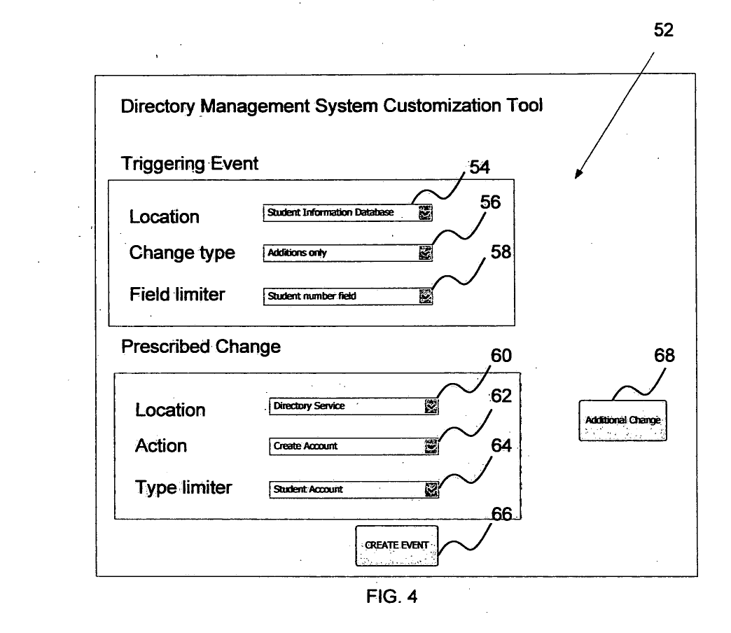

A simplified graphical user interface for the above mentioned software tool is shown in FIG. 4. The interface provides a location for the user to select and enter descriptions for the triggering event and the prescribed change. The interface shown in FIG. 4 illustrates the selections a user may make to cause directory management system 10 to create a student account in the directory service when a new student number is added to the student information database. Location list box 54 provides a listing of the possible locations where a triggering event may occur. The software tool may include a search and filter algorithm for searching and filtering the system for file types that are likely to be a source of a triggering event. An optional “browse” command (not illustrated) may be provided so that an experience user may select a specific directory and file where the triggering event may occur. Change type list box 56 allows the user to select the types of changes that are applicable for triggering events. Examples of possible change types include “Additions only,” “Deletions only,” “Updates only,” and “All changes.” Field limiter list box 58 gives the user the opportunity to limit the types of changes which will be considered a triggering event to a certain field within a file.

As mentioned previously, the software tool also allows the user to select and enter the desired changes to be carried out when the triggering event occurs. Location list box 60 allows the user to select where the change is to be carried out. Action list box 62 enables the user to select the specific type of action that is to be carried out. Action list box 62 maybe configured to recall certain options that are applicable to the location selected by the user in location list box 60. Type limiter list box 64 allows the user to further refine the type of action as appropriate. Command button 68 is provided so that the user may associate multiple additional changes with the triggering event. Once the user has selected all of the prescribed changes that are to be carried out when the triggering event occurs, the user may select command button 66 to save the triggering event to memory 44.

Monitoring device 46 is provided to monitor data source 12 for triggering events which are recorded in memory 44. In the preferred embodiment, monitory device 46 includes a rollup connector for aggregating the data as described before. Monitoring device 46 may be configured many different ways to determine whether a triggering event has occurred. Depending on the quantity and complexity of triggering events that are relevant to a certain organization, monitoring device 46 may be configured to aggregate data from all data systems or only data from specific directories or files. Monitoring device 46 may also incorporate insert/update sorter 16, initial insert query 18, and initial update query 20 as illustrated in FIG. 1 and described previously. In addition, data may be aggregated relationally or nonrelationally.

When monitoring device 46 detects that a triggering event has occurred, software 48 automatically executes the prescribed change to directory service 40 and file system directory 50. An optional validation step may also be provided to verify that the prescribed change described in memory 44 was in fact carried out to directory service 40 and file system directory 50. Since different directory services and networks utilize different management and update commands, software 48 may include a module which detects which type of directory service and network the user has installed on their server in order to ensure compatibility. Accordingly, if directory management system 10 is provided as a standalone software application, it may be desirable to provide multiple platform management configurations. Alternatively, directory management system 10 may be individually configured to the organization's network and directory service requirements.

Although the preceding descriptions contain significant detail they should not be viewed as limiting the invention but rather as providing examples of the preferred embodiments of the invention. As one example, data source 12 can be provided in forms other than standard database and spreadsheet forms. Changing the form of the data, however, does not depart from the spirit and scope of the invention. In addition, the reader will appreciate the aforementioned directory management system 10 or its various functions may be stored on the memory of the server computer or any of the networked computers that are part of the system. The various functions may also be modularized and installed separately on the memory of any single computer or combination of computers in the system. The aforementioned functions may be programmed in various programming languages, and as such, the previously described management system can be written many different ways. Accordingly, the scope of the invention should be determined by the following claims, rather than the examples given.

Having described my invention, I claim:

1. A method for automatically managing and updating a directory service and file system directory for a system having a server and a plurality of networked computers comprising the steps of:
a. describing a triggering event in computer readable code, said triggering event corresponding to an observable change in said system;
b. describing a business rule for said triggering event in computer readable code, said business rule defining a prescribed change in said directory service and said file system directory for said system that is to be executed upon the occurrence of said triggering event;
c. utilizing a first function stored in the memory of said system to monitor for the occurrence of said triggering event in said system; and
d. utilizing a second function stored in the memory of said system to automatically execute said prescribed change in said directory service and said file system directory for said system whenever said triggering event is observed by said first function.

2. The method of claim 1, further comprising:
a. describing a second triggering event in computer readable code, said second triggering event corresponding to a second observable change in said system;
b. describing a second business rule for said second triggering event in computer readable code, said second business rule defining a second prescribed change in said directory service and said file system directory for said system upon the occurrence of said second triggering event;
c. wherein said first function monitors for the occurrence of said triggering event and said second triggering event; and
d. wherein said second function automatically executes said second prescribed change in said directory service and said file system directory for said system whenever said second triggering event is observed by said first function.

3. The method of claim 1, wherein said prescribed change includes
a. creating a new directory entry;
b. linking said new directory entry to an account; and
c. assigning access rights to said directory entry.

4. The method of claim 2, wherein said prescribed change includes
a. creating a new directory entry;
b. linking said new directory entry to an account; and
c. assigning access rights to said directory entry.

5. The method of claim 1, wherein said defined observable change includes an addition of a new user to the system.

6. The method of claim 1, wherein said defined observable change includes a change in a database of said system.

7. The method of claim 1, wherein said defined observable change includes a change in a student information system of said system.

8. The method of claim 1, wherein said defined observable change includes a change in a human resource system of said system.

9. The method of claim 2, said defined observable change further comprising a change in a student information system of said system; and said second defined observable change further comprising a change in a human resource system of said system.

10. A method for automatically managing and updating a directory service and file system directory for a system having a server, a plurality of networked computers, and a database, said method comprising:
a. describing a triggering event in computer readable code, said triggering event corresponding to an observable change in said database;
b. utilizing a rollup connector to aggregate data in said database;
c. utilizing a first function to compare said data aggregated by said rollup connector to identify if said triggering event has occurred; and
d. utilizing a second function to automatically execute a prescribed change in said directory service and said file system directory for said system whenever said triggering event is identified by said first function.

11. The method of claim 1, wherein said prescribed change includes
a. creating a new directory entry;
b. linking said new directory entry to an account; and
c. assigning access rights to said directory entry.

12. The method of claim 10, wherein said defined observable change includes an addition of a new user to said database.

13. The method of claim 10, wherein said defined observable change includes a change in a student information system of said system.

14. The method of claim 10, wherein said defined observable change includes a change in a human resource system of said system.

15. An apparatus for automatically managing a directory service for a system of an organization, said system having a data source for storing information about users of said system, a directory service, and a file system directory, said apparatus comprising:
a. an input device for inputting a description of a triggering event and a business rule in computer readable code, said triggering event corresponding to an observable change in said data source and said business rule defining a prescribed change in said directory service and said file system directory for said system that is to be executed upon the occurrence of said triggering event;
b. a monitoring device for monitoring said data source for said triggering event; and
c. software for automatically executing said prescribed change in said directory service and said file system directory for said system whenever said triggering event is observed by said monitoring device.

16. The apparatus of claim 15, wherein said prescribed change includes
a. creating a new directory entry;
b. linking said new directory entry to an account; and
c. assigning access rights to said directory entry.

17. The apparatus of claim 15, wherein said defined observable change includes an addition of a new user to said database.

18. The apparatus of claim 15, wherein said defined observable change includes a change in a student information system of said system.

19. The apparatus of claim 15, wherein said defined observable change includes a change in a human resource system of said system.
